(19) United States
(12) Patent Application Publication
(10) Pub. No.: US 2009/0253003 A1
(43) Pub. Date: Oct. 8, 2009

(54) FUEL CELL SYSTEM AND METHOD OF SCAVENGING FUEL CELL SYSTEM

(75) Inventors: Yuji Matsumoto, Shioya-gun (JP); Kenichiro Ueda, Utsumomiya-shi (JP); Koichiro Miyata, Utsunomiya-shi (JP)

Correspondence Address: LAHIVE & COCKFIELD, LLP;FLOOR 30, SUITE 3000, ONE POST OFFICE SQUARE, BOSTON, MA, 02109, US

(73) Assignee: Honda Motor Co., Ltd., Tokyo (JP)

(21) Appl. No.: 12/415,516

(22) Filed: Mar. 31, 2009

(30) Foreign Application Priority Data
Apr. 8, 2008 (JP) 2008-100602

(51) Int. Cl. H01M 8/04; H01M 2/02

(52) U.S. Cl. 429/17; 429/34; 429/24

(57) ABSTRACT

A fuel cell system is provided with a fuel cell that supplies fuel gas to an anode electrode and that supplies oxidant gas to a cathode electrode to generate electric power; a scavenging gas supply device that scavenges the inside of the fuel cell; a temperature detection device that detects a temperature of the inside of the fuel cell; a deterioration countermeasure scavenging device that executes deterioration countermeasure scavenging by the scavenging gas supply device and replaces the accumulated gas accumulated in the anode electrode with the scavenging gas; and a sub-zero countermeasure scavenging device that executes sub-zero countermeasure scavenging with a greater flow volume than the scavenging gas supplied during the deterioration countermeasure scavenging and to discharge the generated water in the inside of the fuel cell.

### BACKGROUND OF THE INVENTION

Priority is claimed on Japanese Patent Application No. 2008-100602, filed on Apr. 8, 2008, the contents of which are incorporated herein by reference.

### FIELD OF THE INVENTION

The present invention relates to a fuel cell system and a method of scavenging a fuel cell system.

### DESCRIPTION OF THE RELATED ART

Conventionally, as a fuel cell which is installed for example in a vehicle, a fuel cell stack (referred to hereunder as a fuel cell) which is stacked by a plurality of unit fuel cell (referred to hereunder as a unit cell) is known. In the fuel cell, the unit cell has a flat shape and is formed by arranging a pair of separators on the two sides of a membrane electrode structure. The membrane electrode structure is formed by sandwiching a solid polymer electrolyte membrane from two sides by an anode electrode and a cathode electrode. In such a fuel cell, hydrogen gas is supplied between the anode electrode and the separator as a fuel gas, and air is supplied between the cathode electrode and the separator as an oxidant gas. As a result, hydrogen ions generated by catalytic reactions on the anode electrodes are transmitted through the solid polymer electrolyte membranes to the cathode electrodes, and cause electrochemical reactions with oxygen in the air on the cathode electrodes, so that electric power is generated. Here, water is produced in the fuel cell accompanying the generation of electrical power.

In a fuel cell system having such a fuel cell, if a long time has elapsed from stopping the generation of electric power, there is a possibility that gas (mainly nitrogen gas) that does not take part in the generation of electric power, accumulates on the anode electrode side due to air entering the anode electrode side from the cathode electrode side via the solid polymer electrolyte membrane.

If such accumulated gas exists, it will cause the partial pressure of the hydrogen on the anode electrode side to drop the next time that the fuel cell is started. Therefore there is a problem in that it takes time for the generation of electric power to resume.

In order to solve such a problem, a technique is known in which air (scavenging gas) is supplied to the anode electrode and the cathode electrode while the fuel cell is stopped, and the nitrogen gas (accumulating gas) accumulated in the fuel cell is discharged (for example, refer to Japanese Unexamined Patent Application, First Publication No. 2004-172105 (hereunder, Patent Document 1)). According to a method of operating the fuel cell system of Patent Document 1, when the temperature of the fuel cell drops to 50° C. or below while the fuel cell is stopped, air is supplied to the anode electrode and the cathode electrode. By constructing in this manner, it is possible to suppress chemical reactions occurring in each of the electrodes while the fuel cell is stopped, and as a result, deterioration due to oxidation-reduction of the electrodes is suppressed.

### SUMMARY OF THE INVENTION

In order to address the above problem, a fuel cell system of the present invention is provided with a fuel cell that supplies fuel gas to an anode electrode and that supplies oxidant gas to a cathode electrode to generate electric power; a scavenging gas supply device that scavenges the inside of the fuel cell; a temperature detection device that detects a temperature of the inside of the fuel cell; a deterioration countermeasure scavenging device that executes deterioration countermeasure scavenging to supply scavenging gas to the inside of the fuel cell by the scavenging gas supply device and to replace the accumulated gas accumulated in the anode electrode with the scavenging gas in a case where predetermined time has elapsed from stopping of the operation of the fuel cell; and a sub-zero countermeasure scavenging device that executes sub-zero countermeasure scavenging to supply scavenging gas by the scavenging gas supply device with a greater flow volume than the scavenging gas supplied during the deterioration countermeasure scavenging and to discharge the generated water in the inside of the fuel cell in a case where the temperature of the inside of the fuel cell which is detected by the temperature detection device drops to or below a predetermined temperature after stopping of the operation of the fuel cell.

According to the fuel cell system of the present invention, since accumulated gas in the fuel cell can be scavenged using the deterioration countermeasure scavenging device, deterioration of the fuel cell can be suppressed. Furthermore, since generated water accumulated in the fuel cell can be scavenged using the sub-zero countermeasure scavenging device, it is possible to prevent the generated water from freezing in the fuel cell. Therefore the startability and power generation performance of the fuel cell can be ensured.

In the case where the sub-zero countermeasure scavenging is executed prior to the deterioration countermeasure scavenging, the deterioration countermeasure scavenging may not be executed.

In this case, by first executing sub-zero countermeasure scavenging, not only the generated water can be discharged, but also the accumulated gas in the fuel cell can be replaced with scavenging gas. Accordingly, it is not necessary to execute deterioration countermeasure scavenging, so that it is possible to reduce the energy necessary for deterioration countermeasure scavenging.

In the case where the temperature of the fuel cell detected by the temperature detection device drops to or below the predetermined temperature after the deterioration countermeasure scavenging is executed, the sub-zero countermeasure scavenging may be executed.

In this case, if the temperature of the fuel cell does not drop to or below freezing point after deterioration countermeasure scavenging is executed, there is no concern about the generated water freezing. Therefore, it is not necessary to execute sub-zero countermeasure scavenging. Accordingly, it is possible for the accumulated gas in the fuel cell to be replaced with scavenging gas, and for the deterioration of the fuel cell to be suppressed, and for the energy necessary for sub-zero countermeasure scavenging to be reduced.

Furthermore, in the case where the temperature of the fuel cell drops to or below freezing point after deterioration countermeasure scavenging is executed, sub-zero countermeasure scavenging is executed to discharge generated water accumulated in the fuel cell, so that it is possible to prevent the generated water from freezing.

A flow volume of the scavenging gas supplied during the sub-zero countermeasure scavenging, in the case where the sub-zero countermeasure scavenging is executed after the deterioration countermeasure scavenging, may be less than a flow volume of the scavenging gas supplied during the sub-zero countermeasure scavenging in the case where the sub-zero countermeasure scavenging is executed before the deterioration countermeasure scavenging.

In this case, since part of the generated water can be discharged using the scavenging gas when deterioration countermeasure scavenging is executed, it is possible to reduce the flow volume to match the flow volume of the scavenging gas necessary to discharge the generated water already discharged at the time of the succeeding sub-zero countermeasure scavenging. Accordingly, it is possible to reduce the energy necessary for sub-zero countermeasure scavenging.

After sub-zero countermeasure scavenging is executed, the temperature detection device may stop detection of the temperature of the inside of the fuel cell.

In this case, since there is no generated water left in the fuel cell after sub-zero countermeasure scavenging is executed, it is not necessary to monitor the temperature of the fuel cell. Accordingly, it is possible to reduce the energy necessary to detect the temperature of the fuel cell.

An air compressor that supplies cathode gas may be further provided, and the scavenging gas may be the cathode gas.

An energy storage unit that stores electrical energy generated by the fuel cell may be further provided, and electrical energy which may be necessary for executing the deterioration countermeasure scavenging and the sub-zero countermeasure scavenging is supplied from the energy storage unit.

A method of scavenging a fuel cell system of the present invention, which utilizes scavenging gas to scavenge the inside of a fuel cell having an anode electrode and a cathode electrode, which generates electric power by a chemical reaction of a fuel gas and an oxidant gas, the method is provided with: a deterioration countermeasure scavenging step to supply the scavenging gas to the inside of the fuel cell and to replace the accumulated gas accumulated in the anode electrode with the scavenging gas in a case where a first predetermined time has elapsed from stopping of the operation of the fuel cell; a time detection step to detect whether or not a second predetermined time has elapsed from stopping of the operation of the fuel cell; a temperature detection step to detect a temperature of the inside of the fuel cell when the second predetermined time has elapsed; and a sub-zero countermeasure scavenging step to supply the scavenging gas which has a greater flow volume than the scavenging gas supplied during the deterioration countermeasure scavenging step and to discharge the generated water in the inside of the fuel cell in a case where the temperature of the inside of the fuel cell which is detected in the temperature detection step drops to or below a predetermined temperature.

In this case, since the accumulated gas in the fuel cell can be scavenged in the deterioration countermeasure scavenging step, deterioration of the fuel cell can be suppressed. Furthermore, since the generated water accumulated in the fuel cell can be scavenged in the sub-zero countermeasure scavenging step, it is possible to prevent the generated water from freezing in the fuel cell. Therefore the startability and power generation performance of the fuel cell can be ensured.

In the case where the sub-zero countermeasure scavenging step is executed prior to the deterioration countermeasure scavenging step, the deterioration countermeasure scavenging step may not be executed.

In this case, by first executing the sub-zero countermeasure scavenging step, not only the generated water can be discharged, but also the accumulated gas in the fuel cell can be replaced with scavenging gas. Accordingly, since it is not necessary to execute the deterioration countermeasure scavenging step, it is possible to reduce the energy necessary for the deterioration countermeasure scavenging step.

In the case where the temperature of the fuel cell drops to or below the predetermined temperature after the deterioration countermeasure scavenging step, the sub-zero countermeasure scavenging step may be executed.

In this case, if the temperature of the fuel cell does not drop to or below freezing point after the deterioration countermeasure scavenging step is executed, there is no concern about the generated water freezing. Therefore, it is not necessary to execute the sub-zero countermeasure scavenging step. Accordingly, it is possible for the accumulated gas in the fuel cell to be replaced with scavenging gas, and for the deterioration of the fuel cell to be suppressed, and for the energy necessary for the sub-zero countermeasure scavenging step to be reduced.

Moreover, in the case where the temperature of the fuel cell drops to or below freezing point after the deterioration countermeasure scavenging step is executed, the sub-zero countermeasure scavenging step is executed to discharge the generated water regardless of whether or not the deterioration countermeasure scavenging step is executed, so that it is possible to prevent the generated water from freezing.

A flow volume of the scavenging gas supplied during the sub-zero countermeasure scavenging step, in the case where the sub-zero countermeasure scavenging step is executed after the deterioration countermeasure scavenging step, may be less than a flow volume of the scavenging gas supplied during the sub-zero countermeasure scavenging step in the case where the sub-zero countermeasure scavenging step is executed before the deterioration countermeasure scavenging step.

In this case, since part of the generated water can be discharged using the scavenging gas when the deterioration countermeasure scavenging step is executed, it is possible to reduce the flow volume to match the flow volume of the scavenging gas necessary to discharge the generated water already discharged at the time of the succeeding sub-zero countermeasure scavenging step. Accordingly, it is possible to reduce the energy necessary for the sub-zero countermeasure scavenging step.

After the sub-zero countermeasure scavenging step, detection of the temperature of the inside of the fuel cell in the temperature detection step may be stopped.

In this case, since there is no generated water left in the fuel cell after the sub-zero countermeasure scavenging step is executed, it is not necessary to monitor the temperature of the fuel cell. Accordingly, it is possible to reduce the energy necessary to detect the temperature of the fuel cell.

Every time that the second predetermined time has elapsed from stopping of the operation of the fuel cell, detection of the temperature of the inside of the fuel cell may be executed in the temperature detection step.

### BRIEF DESCRIPTION OF THE DRAWINGS

FIG. 1 is a schematic structural diagram of a fuel cell system of a first embodiment of the present invention.

FIG. 2 is a schematic block diagram of a control section of the embodiment.

FIG. 3 is a flow chart showing a method of scavenging of the fuel cell system of the embodiment.

FIG. 4 is a flow chart showing a subroutine of sub-zero countermeasure scavenging of the embodiment.

### DETAILED DESCRIPTION OF THE INVENTION

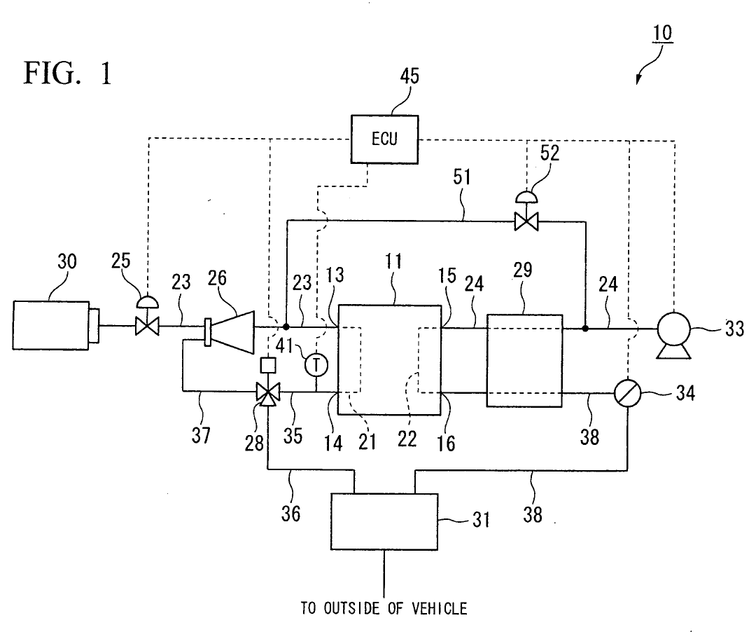

Next is a description of an embodiment of the present invention based on FIG. 1 to FIG. 4. In the present embodiment, a case will be described in which a fuel cell system is installed in a vehicle.

### (Fuel Cell System)

FIG. 1 is a schematic structural diagram of a fuel cell system.

As shown in FIG. 1, a fuel cell 11 of a fuel cell system 10 is a solid polymeric membrane type fuel cell, which generates electric power by an electrochemical reaction with a fuel gas such as hydrogen gas and an oxidant gas such as air. A fuel gas supply pipe 23 is connected to a fuel gas supply communicating opening 13 (entry end of a fuel gas channel 21) formed in the fuel cell 11, and a hydrogen tank 30 is connected to its upstream end. Furthermore, an oxidant gas supply pipe 24 is connected to an oxidant gas supply communicating opening 15 (entry end of an oxidant gas channel 22) formed in the fuel cell 11, and an air compressor 33 is connected to its upstream end. In addition, an anode off gas discharge pipe 35 is connected to an anode off-gas discharge interconnecting opening 14 (exit end of the fuel gas channel 21) formed in the fuel cell 11, and a cathode off-gas discharge pipe 38 is connected to a cathode off-gas discharge communicating opening 16 (exit end of the oxidant gas channel 22).

Hydrogen gas supplied to the fuel gas supply pipe 23 from the hydrogen tank 30 is supplied to the fuel gas channel 21 of the fuel cell 11 through an ejector 26 after being decompressed by a regulator (not shown in the figure). Moreover, an electromagnetic drive type solenoid valve 25 is provided in the vicinity of the downstream side of the hydrogen tank 30, so that the supply of hydrogen gas from the hydrogen tank 30 can be cut off.

Furthermore, an electromagnetic drive type purge valve 28, comprising a three way valve, is provided in the anode off-gas discharge pipe 35. A gas discharge pipe 36 and an anode off-gas return pipe 37 are connected to the purge valve 28, and a gas channel is formed selectively by the purge valve 28. The gas discharge pipe 36 is connected to a dilution box 31, and it is constructed such that anode off-gas is subsequently discharged to outside of the vehicle. On the other hand, the anode off-gas return pipe 37 is connected to the ejector 26, and anode off-gas that has passed through the fuel cell 11 can be reused as anode gas of the fuel cell 11.

Next, air (oxidant gas) is pressurized by the air compressor 33, humidified by a humidifier 29, and after passing through the oxidant gas supply pipe 24, is supplied to the oxidant gas channel 22 of the fuel cell 11. After the oxygen in this air has been used for generation of electric power as an oxidizing agent, cathode off-gas is discharged to the cathode off-gas discharge pipe 38 from the fuel cell 11. The cathode off-gas discharge pipe 38 is connected to the humidifier 29, while the cathode off-gas discharge pipe 38 connected to the discharge side of the humidifier 29 is connected to the dilution box 31, and cathode off-gas is subsequently discharged to outside of the vehicle. In addition, a back-pressure valve 34 is provided in the cathode off-gas discharge pipe 38.

Here, a temperature sensor 41 is provided immediately after (on the downstream side of) the anode off-gas discharge communication opening 14 in the anode off-gas discharge pipe 35. By means of the temperature sensor 41, it is possible to detect a temperature that is almost the same as that of the inside of the fuel cell 11. The detection result (sensor output) of the temperature sensor 41 is transmitted to a control unit (ECU) 45, and it is determined whether or not to execute sub-zero countermeasure scavenging (described later) of the fuel cell 11 based on the detection result.

Moreover, the oxidant gas supply pipe 24, which connects between the air compressor 33 and the humidifier 29, is branched and connected to one end of the scavenging gas introducing pipe 51. The other end of the scavenging gas introducing pipe 51 is connected between the ejector 26 and the fuel cell 11 in the fuel gas supply pipe 23. That is, it is possible to supply air to the fuel gas channel 21 of the fuel cell 11. In addition, an electromagnetic drive type solenoid valve 52 is provided in the scavenging gas introducing pipe 51, so that the supply of air from the air compressor 33 can be cut off.

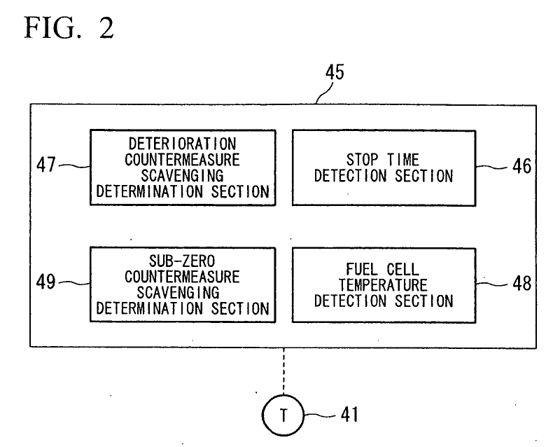

FIG. 2 is a schematic block diagram of the control unit 45. As shown in FIG. 2, the control unit 45 is provided with: a stop time detection section 46 which measures the time elapsed from after the fuel cell system 10 is stopped; a deterioration countermeasure scavenging determination section 47 which determines whether or not deterioration countermeasure scavenging inside the fuel cell 11 will be executed when the time measured by the stop time detection section 46 has reached a predetermined time; a fuel cell temperature detection section 48 which instructs the temperature sensor 41 to send a temperature signal at predetermined intervals of time, and detects the temperature signal input from the temperature sensor 41; and a sub-zero countermeasure scavenging determination section 49 which determines whether or not sub-zero countermeasure scavenging inside the fuel cell 11 will be executed based on the temperature detected by the fuel cell temperature detection section 48.

Furthermore, the control unit 45 can control the solenoid valve 25 according to the output requested by the fuel cell 11, to supply a predetermined amount of hydrogen gas from the hydrogen tank 30 to the fuel cell 11. Moreover, it is constructed such that it can control the purge valve 28 to adjust the amount of anode off-gas discharged, and also it can adjust whether the anode off-gas is guided to the gas discharge pipe 36 side to be discharged to outside of the vehicle, or is guided to the anode off-gas return pipe 37 side to be reused as anode gas.

Moreover, the control unit 45 can drive the air compressor 33 to supply a predetermined volume of air to the fuel cell 11 according to the output requested by the fuel cell 11, and also can control the back-pressure valve 34 to adjust the supply pressure of air to the oxidant gas channel 22.

Furthermore, when the inside of the fuel cell 11 is scavenged based on an instruction from the deterioration countermeasure scavenging determination section 47 or the sub-zero countermeasure scavenging determination section 49, it can control the solenoid valve 52 of the scavenging gas introducing pipe 51 to supply a predetermined amount of air (oxidant gas) to the fuel gas channel 21 of the fuel cell 11.

### (Method of Scavenging of Fuel Cell System)

Next is a description of a method of scavenging of the fuel cell system 10.

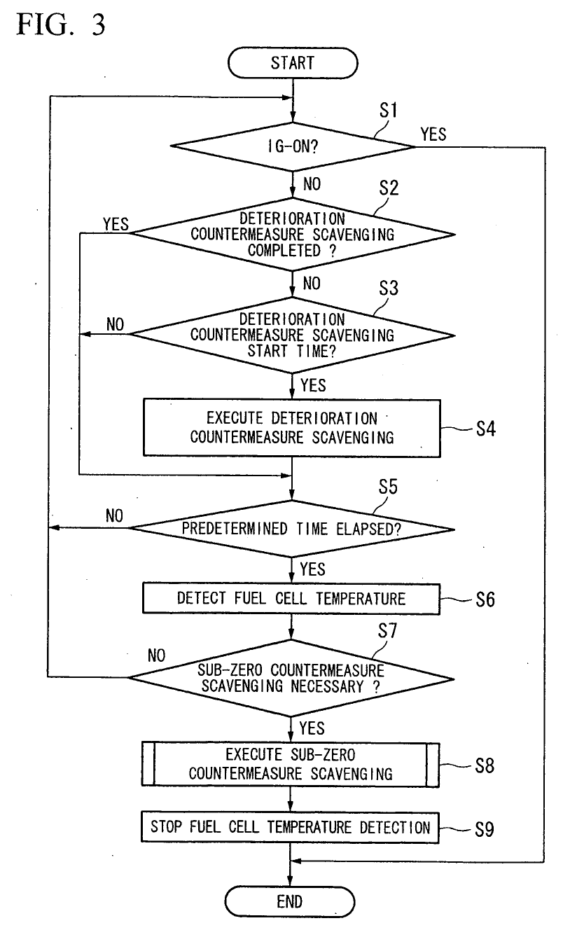

FIG. 3 is a flow chart of a method of scavenging of the fuel cell system 10.

As shown in FIG. 3, in S1, it is detected whether an ignition switch (not shown in the figure), being a drive signal of the fuel cell system 10, is on or off. In the case where the ignition switch is on, the fuel cell system 10 is started, so scavenging is not necessary, and processing is terminated. In the case where the ignition switch is off, the flow proceeds to S2.

In S2, it is determined whether or not deterioration countermeasure scavenging has already been executed since the fuel cell system 10 was stopped. In the case where deterioration countermeasure scavenging has already been executed, deterioration countermeasure scavenging is not executed, so the flow proceeds to S5. In the case where deterioration countermeasure scavenging has not been executed yet, the flow proceeds to S3.

In S3, the time after the fuel cell system 10 was stopped is measured by the stop time detection section 46, and it is determined whether or not the elapsed time (first predetermined time) has exceeded a deterioration countermeasure scavenging time (for example, 3 hours). In the case where it has not exceeded the deterioration countermeasure scavenging time yet, the flow proceeds to S5, and in the case where it has exceeded the deterioration countermeasure scavenging time, the flow proceeds to S4.

In S4, deterioration countermeasure scavenging of the fuel cell 11 is executed (deterioration countermeasure scavenging step). To be specific, the solenoid valve 52 of the scavenging gas introducing pipe 51 is set to be in an open state. Then, the purge valve 28 is adjusted such that the scavenged gas discharged is guided to the gas discharge pipe 36. Then, the compressor 33 is driven to supply air (scavenging gas) to the fuel gas channel 21 of the fuel cell 11, and the accumulated gas accumulated in the fuel gas channel 21 is replaced. At this time, by being replaced with the scavenging gas, the discharged gas also contains anode off-gas. Accordingly, in order to dilute the anode off-gas, air is also supplied to the cathode side. Here, the flow volume of the scavenging gas should be a flow volume that can replace the contents of the fuel gas channel 21 with scavenging gas. When deterioration countermeasure scavenging of the fuel cell 11 is completed, the flow proceeds to S5.

In S5, the time after the fuel cell system 10 was stopped is measured by the stop time detection section 46, and it is determined whether or not the elapsed time (second predetermined time) has exceeded the time to start detecting whether the temperature of the fuel cell 11 is a predetermined temperature, or below, in order to determine whether or not sub-zero countermeasure scavenging is to be executed. In the case where it has not exceeded the detection start time, the flow returns to S1, and in the case where it has exceeded it, the flow proceeds to S6. That is, since the temperature of the fuel cell 11 is at a high temperature immediately after the fuel cell system 10 is stopped, energy can be saved by omitting the temperature detection.

In addition, the arrangement may be such that by setting the elapsed time (second predetermined time) in S5 as an interval time, for example 5 minutes, the flow proceeds to S6 every 5 minutes (once every 5 minutes) after the fuel cell system 10 is stopped.

In S6, the temperature of the fuel cell 11 is detected by the temperature sensor 41, whose signal is output to the fuel cell temperature detection section 48 (temperature detection step). The timing of detecting the temperature by the temperature sensor 41 is set by the fuel cell temperature detection section 48. When the temperature of the fuel cell 11 is detected, the flow proceeds to S7.

In S7, it is determined in the sub-zero countermeasure scavenging determination section 49 whether or not sub-zero countermeasure scavenging of the fuel cell 11 is to be executed. To be specific, if the temperature input from the temperature sensor 41 has not reached freezing point or below (0° C. or below), the generated water accumulated in the fuel cell 11 does not freeze, so the flow returns to S1. On the other hand, in the case where the temperature of the fuel cell 11 is at freezing point or below, there is concern about the generated water freezing, so the flow proceeds to S8.

In S8, sub-zero countermeasure scavenging of the fuel cell 11 is executed (sub-zero countermeasure scavenging step). To be specific, the solenoid valve 52 of the scavenging gas introducing pipe 51 is set to be in an open state. Then, the purge valve 28 is adjusted such that the scavenged gas discharged is guided to the gas discharge pipe 36. Then, the compressor 33 is driven to supply air (scavenging gas) to the fuel gas channel 21 of the fuel cell 11, and the generated water accumulated in the fuel gas channel 21 is replaced with scavenging gas. At the same time, the air guided from the compressor 33 is supplied to the oxidant gas channel 22 of the fuel cell 11, and the generated water accumulated in the oxidant gas channel 22 is replaced with scavenging gas. The generated water and accumulated gas discharged from the fuel gas channel 21 and the oxidant gas channel 22 are guided to the dilution box 31, and subsequently discharged to outside of the vehicle.

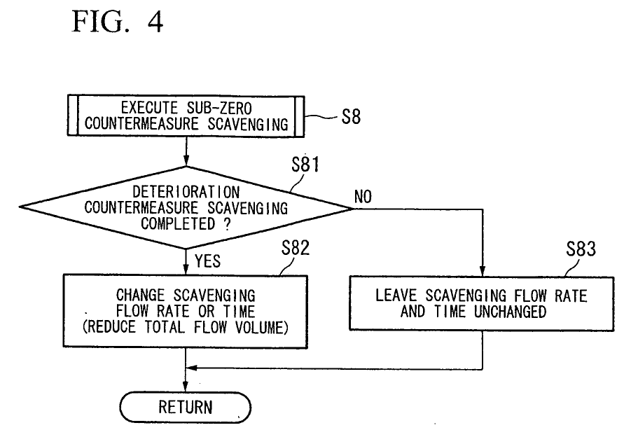

When executing sub-zero countermeasure scavenging, two patterns can be considered. FIG. 4 is a flow chart of a subroutine in the case where sub-zero countermeasure scavenging is executed. As shown in FIG. 4, in S81 it is determined whether or not deterioration countermeasure scavenging has already been executed. In the case where deterioration countermeasure scavenging has already been executed since the fuel cell system 10 was stopped, the flow proceeds to S82, and in the case where deterioration countermeasure scavenging has not been executed, the flow proceeds to S83.

In S82, since deterioration countermeasure scavenging has already been executed since the fuel cell system 10 was stopped, the fuel gas channel 21 of the fuel cell 11 is replaced with scavenging gas, so there is no accumulated gas. Accordingly, only the generated water accumulated in the fuel cell 11 should be discharged, so the flow volume of the total volume of the scavenging gas is adjusted to be less than a predetermined flow volume. The method of adjusting the flow volume of the total volume of the scavenging gas varies depending on whether the velocity of the scavenging gas should be low, or the time to supply the scavenging gas should be low. Then, sub-zero countermeasure scavenging in the fuel cell 11 is executed, and the flow returns to S9 in the main routine.

In S83, since deterioration countermeasure scavenging has not been executed since the fuel cell system 10 was stopped, both the accumulated gas and generated water are accumulated in the fuel cell 11. Accordingly, the setting is such that scavenging gas for sub-zero countermeasure scavenging is supplied to the fuel cell 11 at a predetermined flow volume. That is, the setting is such that the flow volume of scavenging gas of sub-zero countermeasure scavenging is greater than that of scavenging gas of deterioration countermeasure scavenging. Then, sub-zero countermeasure scavenging in the fuel cell 11 is executed, and the flow returns to S9 in the main routine. The case of S83 is one where the fuel cell 11 has cooled rapidly after the fuel cell system 10 was stopped in a situation such as where the outside air is extremely cold, so that the fuel cell 11 reaches freezing point before the deterioration countermeasure scavenging time, during which deterioration countermeasure scavenging is executed, has elapsed.

In S9, the temperature of the fuel cell 11 is detected by the temperature sensor 41 in order to determine whether or not sub-zero countermeasure scavenging is to be executed. However, this temperature detection is stopped, and processing terminates. Accordingly, it is possible to save the energy necessary for temperature detection.

The electrical power required at the time of the above-described deterioration countermeasure scavenging and sub-zero countermeasure scavenging is ensured for example from an energy storage unit (not shown in the figure) that stores the electrical energy of the fuel cell.

According to the present embodiment, since the accumulated gas in the fuel cell 11 can be scavenged by deterioration countermeasure scavenging, deterioration of the fuel cell 11 can be suppressed. Furthermore, since the generated water accumulated in the fuel cell 11 can be scavenged by sub-zero countermeasure scavenging, it is possible to prevent the generated water from freezing in the fuel cell 11. Therefore the startability and power generation performance of the fuel cell 11 can be ensured. Moreover, damage of the fuel cell 11 due to the generated water freezing, can be prevented.

Furthermore, when sub-zero countermeasure scavenging is executed first, not only can the generated water in the fuel cell 11 be discharged, but also the accumulated gas can be replaced with scavenging gas. Accordingly, since it is not necessary to execute deterioration countermeasure scavenging, it is possible to reduce the energy necessary for deterioration countermeasure scavenging.

Moreover, in the case where the temperature of the fuel cell 11 does not drop to or below freezing point while the fuel cell system 10 is stopped, there is no concern about the generated water freezing. Therefore it is not necessary to execute sub-zero countermeasure scavenging. Accordingly, it is possible for only deterioration countermeasure scavenging to be executed, for the accumulated gas in the fuel cell 11 to be replaced with scavenging gas, and for the deterioration of the fuel cell 11 to be suppressed, and for the energy necessary for sub-zero countermeasure scavenging to be reduced.

On the other hand, in the case where the temperature of the fuel cell 11 drops to or below freezing point, the generated water accumulated in the fuel cell 11 is discharged regardless of whether or not deterioration countermeasure scavenging is executed, so that it is possible to prevent the generated water from freezing.

Furthermore, since part of the generated water accumulated in the fuel cell 11 can be discharged by executing deterioration countermeasure scavenging, it is possible to reduce the flow volume to match the flow volume of the scavenging gas necessary to discharge the generated water already discharged at the time of the succeeding sub-zero countermeasure scavenging. Accordingly, it is possible to reduce the energy necessary for sub-zero countermeasure scavenging.

Since there is no generated water left in the fuel cell 11 after sub-zero countermeasure scavenging is executed, it is not necessary to monitor the temperature of the fuel cell 11. Accordingly, it is possible to reduce the energy necessary to detect the temperature of the fuel cell 11.

The technical field of the present invention is not limited to the above-described embodiment and includes any addition of a range of modifications to the above-described embodiment provided they do not depart from the gist of the invention. That is, the specific constructions and structures offered in the embodiment are only examples, so appropriate modification is possible.

For example, in the present embodiment, the construction is such that the temperature sensor for detecting the temperature of the fuel cell is installed in the anode off-gas discharge pipe. However, the temperature of the fuel cell may be detected directly, and also the temperature of the cathode off-gas discharge pipe, refrigerant, gas, or peripheral auxiliary equipment may be used as alternative temperatures. Furthermore, temperature sensors may be installed not only in one place but also in a plurality of places. In that case, the arrangement may be such that the temperature of any one of them is detected, or an average value of the temperature sensors is obtained.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A fuel cell system comprising:
a fuel cell that supplies fuel gas to an anode electrode and that supplies oxidant gas to a cathode electrode to generate electric power;
a scavenging gas supply device that scavenges the inside of the fuel cell;
a temperature detection device that detects a temperature of the inside of the fuel cell;
a deterioration countermeasure scavenging device that executes deterioration countermeasure scavenging to supply scavenging gas to the inside of the fuel cell by the scavenging gas supply device and to replace the accumulated gas accumulated in the anode electrode with the scavenging gas in a case where predetermined time has elapsed from stopping of the operation of the fuel cell; and
a sub-zero countermeasure scavenging device that executes sub-zero countermeasure scavenging to supply scavenging gas by the scavenging gas supply device with a greater flow volume than the scavenging gas supplied during the deterioration countermeasure scavenging and to discharge the generated water in the inside of the fuel cell in a case where the temperature of the inside of the fuel cell which is detected by the temperature detection device drops to or below a predetermined temperature after stopping of the operation of the fuel cell.

2. A fuel cell system according to claim 1, wherein
in the case where the sub-zero countermeasure scavenging is executed prior to the deterioration countermeasure scavenging, the deterioration countermeasure scavenging is not executed.

3. A fuel cell system according to claim 1, wherein
in the case where the temperature of the fuel cell detected by the temperature detection device drops to or below the predetermined temperature after the deterioration countermeasure scavenging is executed, the sub-zero countermeasure scavenging is executed.

4. A fuel cell system according to claim 3, wherein
a flow volume of the scavenging gas supplied during the sub-zero countermeasure scavenging, in the case where the sub-zero countermeasure scavenging is executed after the deterioration countermeasure scavenging, is less than a flow volume of the scavenging gas supplied during the sub-zero countermeasure scavenging in the case where the sub-zero countermeasure scavenging is executed before the deterioration countermeasure scavenging.

5. A fuel cell system according to claim 1, wherein
after sub-zero countermeasure scavenging is executed, the temperature detection device stops detection of the temperature of the inside of the fuel cell.

6. A fuel cell system according to claim 2, wherein
after sub-zero countermeasure scavenging is executed, the temperature detection device stops detection of the temperature of the inside of the fuel cell.

7. A fuel cell system according to claim 3, wherein
after sub-zero countermeasure scavenging is executed, the temperature detection device stops detection of the temperature of the inside of the fuel cell.

8. A fuel cell system according to claim 4, wherein
after sub-zero countermeasure scavenging is executed, the temperature detection device stops detection of the temperature of the inside of the fuel cell.

9. A fuel cell system according to claim 1, further comprising
an air compressor that supplies cathode gas is further provided, wherein
the scavenging gas is the cathode gas.

10. A fuel cell system according to claim 1, further comprising
an energy storage unit that stores electrical energy generated by the fuel cell is further provided, wherein
electrical energy which is necessary for executing the deterioration countermeasure scavenging and the sub-zero countermeasure scavenging is supplied from the energy storage unit.

11. A method for scavenging a fuel cell system, which utilizes scavenging gas to scavenge the inside of a fuel cell having an anode electrode and a cathode electrode, which generates electric power by a chemical reaction of a fuel gas and an oxidant gas, the method comprising:
a deterioration countermeasure scavenging step to supply the scavenging gas to the inside of the fuel cell and to replace the accumulated gas accumulated in the anode electrode with the scavenging gas in a case where a first predetermined time has elapsed from stopping of the operation of the fuel cell;
a time detection step to detect whether or not a second predetermined time has elapsed from stopping of the operation of the fuel cell;
a temperature detection step to detect a temperature of the inside of the fuel cell when the second predetermined time has elapsed; and
a sub-zero countermeasure scavenging step to supply the scavenging gas which has a greater flow volume than the scavenging gas supplied during the deterioration countermeasure scavenging step and to discharge the generated water in the inside of the fuel cell in a case where the temperature of the inside of the fuel cell which is detected in the temperature detection step drops to or below a predetermined temperature.

12. A method of scavenging a fuel cell system according to claim 11, wherein
in the case where the sub-zero countermeasure scavenging step is executed prior to the deterioration countermeasure scavenging step, the deterioration countermeasure scavenging step is not executed.

13. A method of scavenging a fuel cell system according to claim 11, wherein
in the case where the temperature of the inside of the fuel cell detected in the temperature detection step drops to or below the predetermined temperature after the deterioration countermeasure scavenging step, the sub-zero countermeasure scavenging step is executed.

14. A method of scavenging a fuel cell system according to claim 13, wherein
a flow volume of the scavenging gas supplied during the sub-zero countermeasure scavenging step, in the case where the sub-zero countermeasure scavenging step is executed after the deterioration countermeasure scavenging step, is less than a flow volume of the scavenging gas supplied during the sub-zero countermeasure scavenging step in the case where the sub-zero countermeasure scavenging step is executed before the deterioration countermeasure scavenging step.

15. A method of scavenging a fuel cell system according to claim 11, wherein
after the sub-zero countermeasure scavenging step, detection of the temperature of the inside of the fuel cell in the temperature detection step is stopped.

16. A method of scavenging a fuel cell system according to claim 12, wherein
after the sub-zero countermeasure scavenging step, detection of the temperature of the inside of the fuel cell in the temperature detection step is stopped.

17. A method of scavenging a fuel cell system according to claim 13, wherein
after the sub-zero countermeasure scavenging step, detection of the temperature of the inside of the fuel cell in the temperature detection step is stopped.

18. A method of scavenging a fuel cell system according to claim 14, wherein
after the sub-zero countermeasure scavenging step, detection of the temperature of the inside of the fuel cell in the temperature detection step is stopped.

19. A method of scavenging a fuel cell system according to claim 11, wherein
every time that the second predetermined time has elapsed from stopping of the operation of the fuel cell, detection of the temperature of the inside of the fuel cell is executed in the temperature detection step.
